(19) United States
(12) Patent Application Publication
(10) Pub. No.: US 2013/0015630 A1
(43) Pub. Date: Jan. 17, 2013

(54) MECHANIC'S CREEPER

(71) Applicant: George McAdams, Las Vegas, NV (US)

(72) Inventor: George McAdams, Las Vegas, NV (US)

(21) Appl. No.: 13/181,797

(22) Filed: Jul. 13, 2011

(51) Int. Cl. B62B 11/00

(52) U.S. Cl. 280/32.6

(57) ABSTRACT

A mechanic's creeper that is worn by the user includes a garment, a base attached to the back side of the garment and a plurality of ball casters attached to the base.

### BACKGROUND OF THE INVENTION

The present invention generally relates to a creeper for a mechanic. More particularly, the present invention relates to a creeper for a mechanic that is worn by the mechanic.

Mechanics use creepers to access the undercarriage of a vehicle during a repair or maintenance process. The creepers known in the art rely on a platform with wheels that are typically several inches off the ground. The mechanic typically lies on the platform and then positions the creeper to a desired location under the vehicle. Unfortunately, the additional height added by the wheels to the known creepers make it more difficult for mechanics to maneuver under the vehicle. Darkness is another difficulty that the mechanics have to deal with. In view of this, the mechanic has to carry a light source to see the area on which he is working.

As can be seen, there is a need for a creeper device that is easy to maneuver under the vehicle, does not rise far from the floor, and at the same time provides the mechanic with enough illumination.

### SUMMARY OF THE INVENTION

In one aspect of the present invention, a mechanic's creeper includes a garment, a base attached to the back of the garment, and a plurality of ball casters attached to the base.

In another aspect of the present invention, a mechanics creeper includes a garment, a base attached to the back side of the garment, a plurality of ball casters attached to the base, and a plurality of light sources attached to the front side of the garment.

These and other features, aspects and advantages of the present invention will become better understood with reference to the following drawings, description and claims.

### BRIEF DESCRIPTION OF THE DRAWINGS

FIG. 1 illustrates a back view of a mechanic's creeper device according to an exemplary embodiment of the present invention;

FIG. 2 illustrates a front view of the mechanic's creeper device of FIG. 1;

FIG. 3 illustrates a cross-sectional view of the mechanic's creeper device taken along line 3-3 of FIG. 1; and

FIG. 4 illustrates a cross-sectional view of the mechanic's creeper device taken along line 4-4 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a mechanic's creeper that may be worn by the mechanic. The mechanic's creeper of the present invention has a lower profile regarding the ground compared to the known mechanic creepers, which allows a wide range of motion and movement to the mechanic.

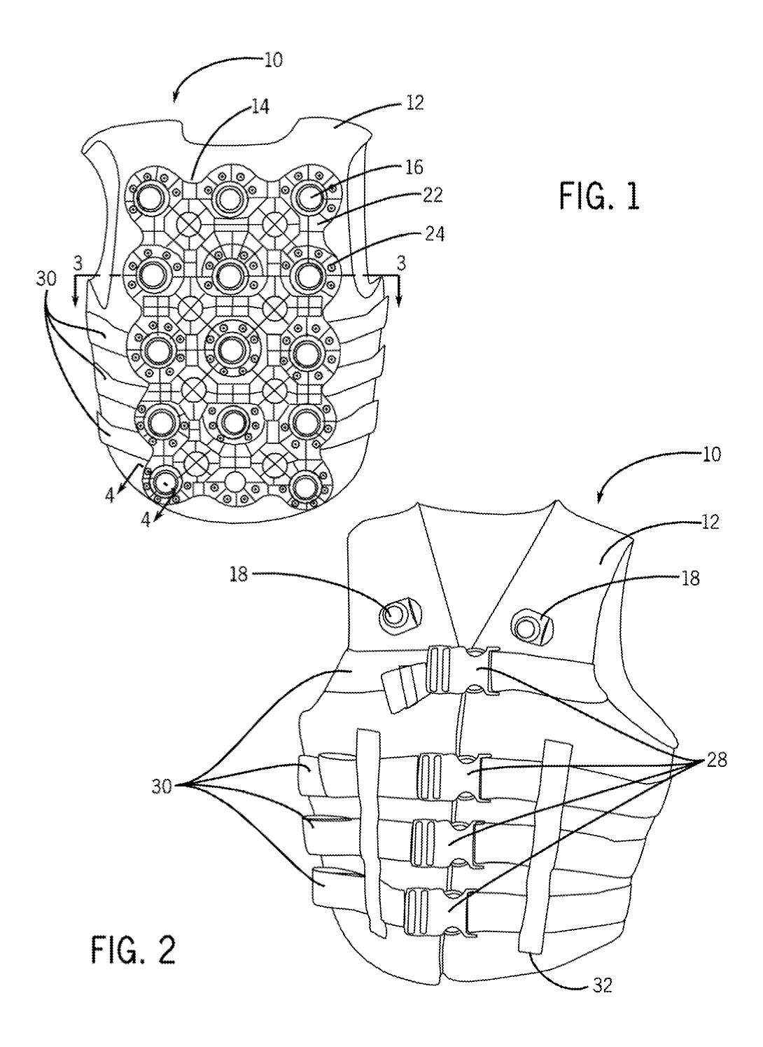

As can be seen on FIGS. 1-4, the mechanic's creeper 10 includes a garment 12, a ball caster assembly 14 attached to the back of the garment 12, a plurality of ball casters 16 attached to the ball caster assembly 14, and at least one light source 18 placed on the front side of the garment 12.

The garment 12 may be designed to allow a mechanic to wear it, lie down, and roll in any direction on a solid floor. The garment 12 may be a vest, a jacket, a shirt, or an undershirt. The garment 12 may be made of a resilient material covered by a soft material. The resilient material may be foam, gel, poly-cushion padding. The soft material may be fabric, nylon, canvas, or cloth. The size of the garment 12 may depend on the size of the user.

The ball caster assembly 14 may facilitate the movement of the user over a solid surface 20 when the user lies down on a horizontal solid surface 20. The ball caster assembly 14 may be attached to the back side of the garment 12. The ball caster assembly 14 may include a base 22. The base 22 may be made of a sturdy material. The sturdy material may be plastic, recycled plastic, Acrylonitrile Butadiene Styrene (ABS), Polyvinyl Chloride (PVC), metal, wood, polymeric material, composite material, stainless steel, and resin.

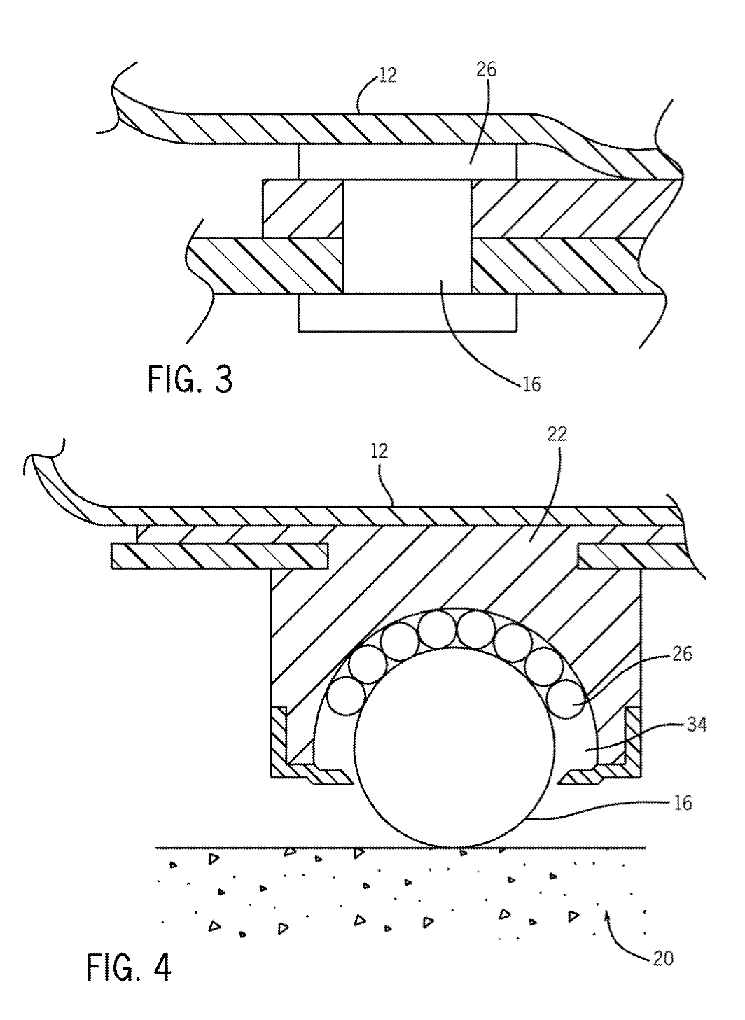

FIGS. 3 and 4 show that a plurality of ball casters 16 may be secured to the base 22. Each ball caster 16 may be mounted on the base 22 by using fasteners 24. The fasteners 24 may be screws or bolts. The ball casters 16 may be distributed on the base 22 forming a pattern that supports the torso of the user while rolling on the horizontal solid surface 20. A portion of each ball caster 16 may be encased inside a depression 34 formed on the base 22. The depression 34 may be a semi-circular shape to match the shape of the ball caster 16. The other portion of each ball caster 16 may be protruding from the base 22. The portion encased inside the base 22 may have a standard ball bearing system 26 located between the base 22 and the ball caster 16. The ball bearing system 26 may facilitate the movement in any direction.

The number, size, and length of the fasteners 24 may be determined by the size of the ball caster 16 and the size of the ball caster assembly 14.

A plurality of straps 30 may be attached to the garment 12. The straps 30 may allow securing the garment 12 to the body of the user. The straps 30 may be made of a flexible but strong material. The straps 30 may be made of plastic, PVC, ABS, magnetic material, and nylon. In some embodiments, the straps 30 may be a magnetic strap to help in removing from the floor small metallic objects such as nuts, bolts, and tools.

The size of the straps 30 may depend on the size of the garment 12. In some embodiments, the size of the strap 30 may be 3 inches wide and ⅛ inches thick. The length of the straps 30 may be adjusted to accommodate the size of the user by using a connecting system 28 attached to the ends of the straps 30. The connecting system 28 may be a standard fastening device that may allow attaching two ends of a strap in an adjustable manner. The straps 30 may be secured to the garment 12 by means of sewn-on loops 32. The straps 30 may easily slide in either direction within the sewn-on loops 32, allowing adjustment for individual sizing by using a connecting system 28. The connecting system 28 may be made of plastic, ABS, PVC, or any synthetic material.

A plurality of light sources 18 may be attached to the front side of the garment 12. The light sources 18 may be battery powered. An on/off switch (not shown) may be used to activate or deactivate the light sources 18. The light sources 18 may be a light-emitting diode light (LED light). The LED light may be an adjustable LED light. The light sources 18 may be secured to the garment by using rivets, screws, hook and loop, stitches, glue, or adhesive. The light sources 18 may include light bulbs, battery, switch, and an enclosure.

The user may wear the mechanic's creeper 10 over his/her clothes with the ball caster assembly 14 towards the back of the garment 12. When preparing to work under a vehicle, the user may simply lie down on his/her back and slide underneath the vehicle. The user may activate the light sources 18 as needed. The built-in light sources 18 may allow the user to always have a light source 18 available, eliminating cords or searching for a flashlight.

It should be understood, of course, that the foregoing relates to exemplary embodiments of the invention and that modifications may be made without departing from the spirit and scope of the invention as set forth in the following claims.

What is claimed is:

1. A mechanic's creeper comprising:
a garment having a front and a back;
a base attached to the back of the garment; and
a plurality of ball casters attached to the base.

2. The mechanic's creeper according to claim 1, wherein the garment is a vest, a jacket, a shirt, or an undershirt.

3. The mechanic's creeper according to claim 1, wherein the garment is made of a resilient material covered by a soft material.

4. The mechanic's creeper according to claim 1, wherein a first section of each ball caster is encased inside the base and wherein a second section of each ball caster protrudes from the base.

5. The mechanic's creeper according to claim 4, further including a ball bearing system located between the first section of each ball caster and the base.

6. The mechanic's creeper according to claim 1, further including a plurality of straps secured to the garment.

7. The mechanic's creeper according to claim 1, wherein the straps are made of a magnetic material.

8. A mechanic's creeper comprising:
a garment having a front side and a back side;
a base attached to the back side of the garment;
a plurality of ball casters attached to the base; and
a plurality of light sources attached to the front side of the garment.

9. The mechanic's creeper according to claim 8, wherein the light sources are light-emitting diode lights.

10. The mechanic's creeper according to claim 8, wherein the garment is a vest, a jacket, a shirt, or an undershirt.
